(19) United States
(12) Patent Application Publication
(10) Pub. No.: US 2006/0237609 A1
(43) Pub. Date: Oct. 26, 2006

(54) Chain link attached hook

(76) Inventor: Kevin O. Spencer, Winterville, NC (US)

Correspondence Address: J. W. GIPPLE, P.O.Box 40513, Washington, DC, 20016, US

(21) Appl. No.: 11/113,800

(22) Filed: Apr. 25, 2005

(51) Int. Cl. F16B 45/00

(52) U.S. Cl. 248/304

(57) ABSTRACT

An s-hook is described, which has a loop formed in its mid-section between its two open-end hooks. The loop is formed around one side of the terminal link in a support chain, thereby being permanently but flexibly attached to the chain. The configuration of the s-hook causes it to be pulled out and away from the support structure.

### CROSS REFERENCE TO RELATED APPLICATIONS

Not applicable

### STATEMENT REGARDING FEDERALLY SPONSORED RESEARCH OR DEVELOPMENT

Not applicable

### INCORPORATED BY REFERENCE OF MATERIAL SUBMITTED ON COMPACT DISK

Not applicable

### BACKGROUND OF THE INVENTION

(1) Field of the Invention

This invention is directed to an s-shaped attachment hook that can be permanently integrated with a chain link.

Link chains are often used as support means because they are very strong, and yet flexible. It is also helpful that all the links are substantially identical and function in the same manner. This allows for the effective length of the chain to be varied according to which particular link is selected as the terminal link. For example, a chain consisting of fifteen links is about fifteen inches when extended from its first link to its terminal fifteenth link. However, if the tenth link is selected as the terminal link to be hooked on to some support structure, then the effective length of the chain is about ten inches, and links 11 through 15 hang unused but still part of the chain. In this way, the tension on the load supported by the chain can be increased or decreased.

The specific context of the present invention is as part of a hammock support system. However, it should be understood that it is applicable to any situation where it may be desirable to vary the effective length of a link chain in a support system.

As shown in Prior Art Illustration, FIG. 1 and FIG. 2, a conventional hammock consists of a hammock bed, extended between two spreader bars and supported by clew ropes which extend through holes in the spreader bars and then funnel toward a merger point where they attach to one end of a clew ring. From the other end of the clew ring, a link chain is attached and functions to connect the clew ring to a support structure, such as a stand. The support structure has a permanently affixed hook, or an aperture into which the terminal end of the chain can be attached. To accomplish this attachment an “s-hook” is employed. As the name implies, it is shaped like the letter “s” and is open on both ends. This shape allows that one end can engage (i.e. hook into) the terminal link of the chain and the opposite end can engage (i.e. hook into) the hook or aperture of the support structure. Using the s-hook, one can vary the effective length of the link chain, by engaging different specific links (selected to function as the “terminal link”). In his manner the effective length of chain can be quickly and easily shortened or lengthened without compromising the strength and flexibility of the chain.

There is one major drawback to use of the s-hook as described above. Because the s-hook is necessarily open at each end, it can be easily disengaged from the terminal link and support hook. It holds engaged when under tension; but when tension is removed, it can easily fall out of engagement. Particularly, providing an s-hook that can be permanently but flexibly attached to a link in chain. This is accomplished by forming the s-hook with an integral loop in the mid-section, between its opposite open ends. This integral loop is formed around one side of the terminal link in the chain. Therefore, while it is still open at each end and can function like a regular s-hook, it is permanently attached to the chain and cannot be lost or mislaid.

Another problem with the conventional s-hook, is that its lower portion into which the terminal link of the chain is attached, tends to rub against the support structure into which its upper portion is hooked. As the hammock swings, the s-hook rubs back and forth across the support structure, abrading it and causing a clanking sound. Because of its length and configuration, the chain link attached hook tends to be pulled by the weight of its load, out and away from the support structure.

(2) Description of Related Art

Applicant is aware of no prior art directly relevant to the present invention.

### BRIEF SUMMARY OF THE INVENTION

In accordance with the present invention, an improved s-hook is formed having a loop in its mid-section between its two open-end hooks. The loop is formed around one side of the terminal link in a support chain, thereby being permanently but flexibly attached to the chain. The configuration of the improved s-hook causes it to be pulled out and away from the support structure so that it doesn't rub against the support structure.

### BRIEF DESCRIPTION OF SEVERAL VIEWS OF THE DRAWINGS

Prior Art Illustration

FIG. 1 is a perspective view of a hammock as attached to a support structures.

FIG. 2 is a detailed perspective view of support chain and s-hook.

The Invention

FIG. 3 is a side plan view of the chain link attached hook

FIG. 4 is a top plan view of the chain link attached hook

FIG. 5 is a perspective view of the chain link attached hook, as attached to a hammock support chain on one end and to a support stand on the other (the support stand illustrated in cross-section)

### DETAILED DESCRIPTION OF THE DRAWINGS

Reference will now be made to a preferred embodiment of the invention as illustrated in the accompanying drawings.

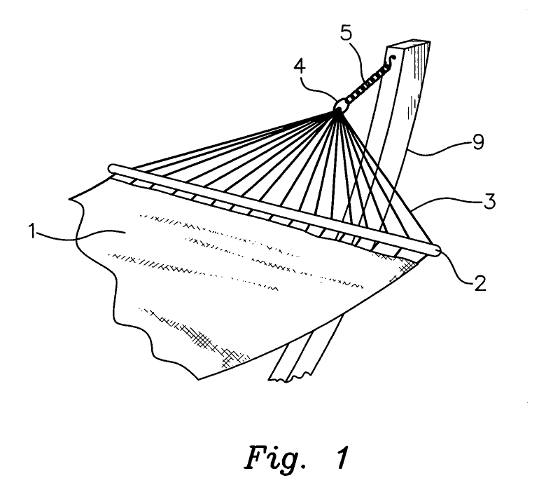

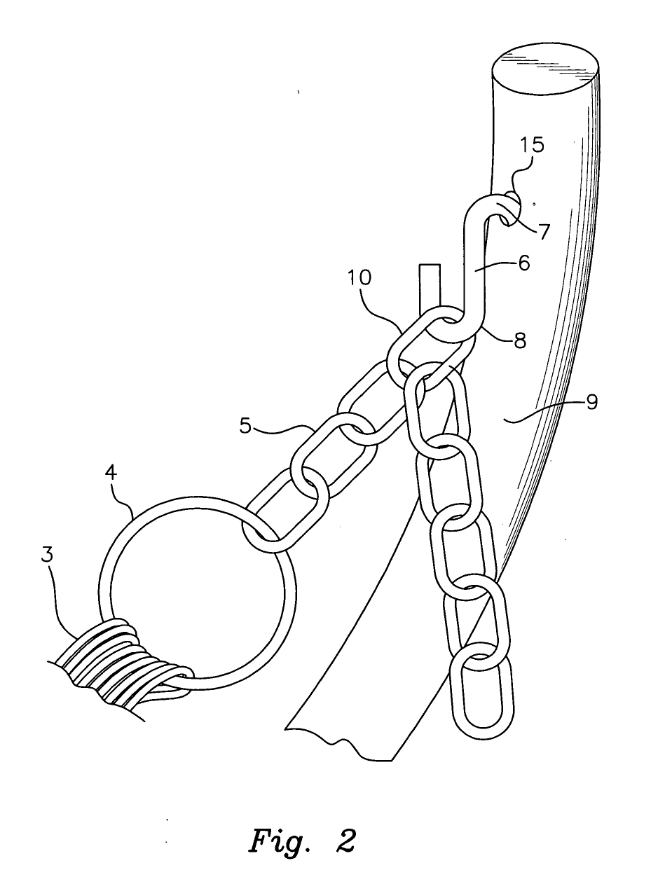

It is necessary to understand the immediate prior art, in order to appreciate the advantages provided by the present invention in the context of its use. A conventional hammock arrangement is shown in FIG. 1. It consists of a hammock bed 1 extended between two spreader bars 2, supported by clew ropes 3 which extend through apertures in the spreader bar 2, and then funnel upwardly toward a merger point where they attach to one side of clew ring 4. On the other side of clew ring 4, a link chain 5 is attached and extends upwardly to a point where it hooks onto support structure 9. There is provided a conventional s-hook 6, which has an upper end hook 7 and a lower end hook 8 supports link chain 5 by means of a terminal 10 that hooks over the lower end hook 8. The reason s-hook 6 is employed is that any one of the links in chain 5, can be hooked over the lower end hook 8 and function as terminal link 10. In the example illustrated FIG. 2, the chain 5 comprises nine links. The fourth link functions as terminal link 10. But any one of the links could function as terminal link 10, thus varying the effective length of chain 5.

The s-hook 6 is necessarily open on each of its ends 7 and 8, so that it can be easily disengaged from terminal link 10 and the support structure 9. It holds engaged while under tension; but when not under tension, it can easily fall out of engagement. When out of engagement the s-hook 6 is often lost because it isn't permanently attached to the chain 5 nor the support structure 9.

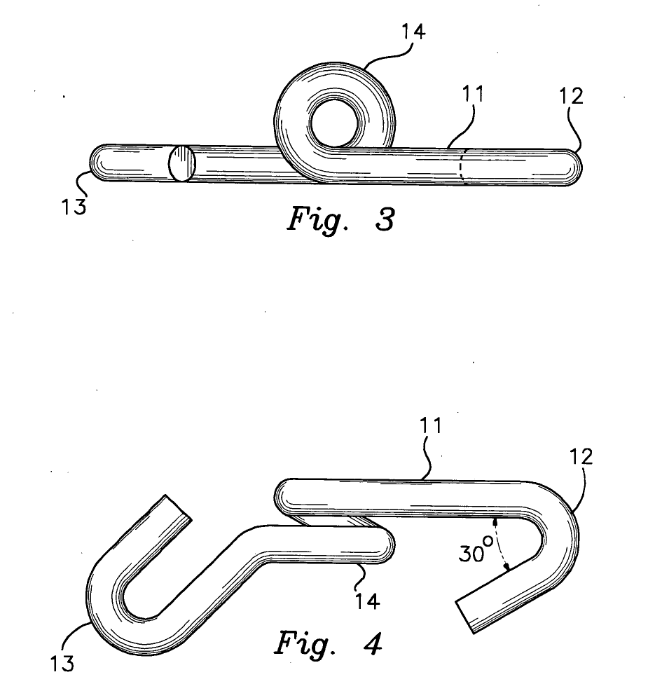

As illustrated in FIGS. 3, 4 and 5, the present invention provides a hook 11 that can function in the same manner as a conventional s-hook but is permanently attached to the link chain 5.

FIG. 3 shows a side view of link attached hook 11, Which has an upper end hook 12 and a lower end hook 13. The body of the hook 11, between ends 12 and 13 includes a loop 14, which is perpendicular to the plane of ends 12 and 13. The upper end hook 12, is formed at a 30° angle to the body of hook 11. The lower end 13, is formed at a 45° angle to the body of hook 11.

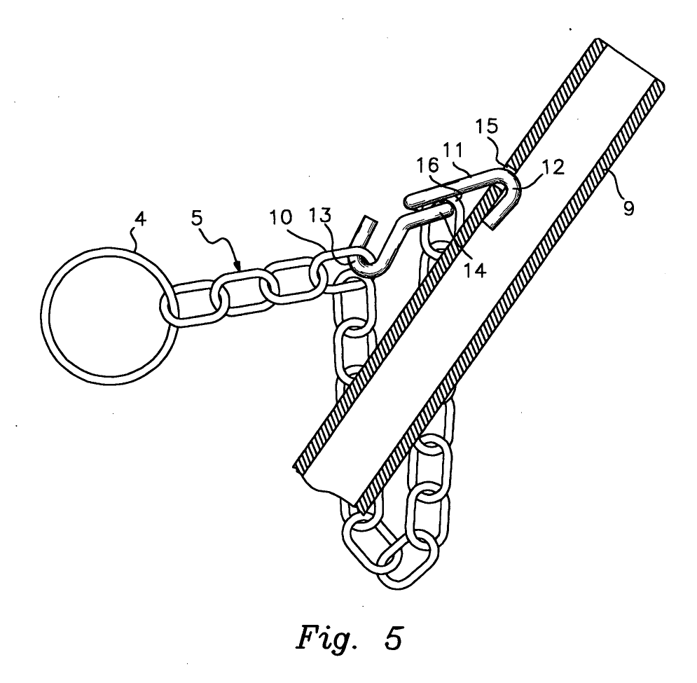

From FIG. 5, it can be seen that the support structure 9 has a hollow interior and has an aperture 15, which is just large enough to accommodate the upper end 12 of hook 11. The loop 14 is formed around one side of the final link 16 in chain 5. It is thus permanently attached to chain 5 and cannot be easily separated therefrom and lost. Any of the links in chain 5 can be selected to function as terminal link 10, thus varying the effective length of the chain. It will also be understood from FIG. 5, that because of the 30° angle of upper end hook 12, it tends to lie flat against the inner wall of support structure 9, which extends the body of hook 11 out and away from the support structure 9. The lower end hook 13 is formed at a 45° angle to the body of hook 11, which makes it more accessible and facilitates the engagement and disengagement of link 10.

From the foregoing, it will be appreciated that the link attached hook 11 provides all of the functional advantages of a conventional s-hook. But it eliminates a major problem of the conventional s-hook, that of becoming disengaged and lost.

It will be further apparent to those skilled in the art that various modifications and variations can be made in the device and method of the present invention without departing from the spirit or scope of the invention. Thus, it is intended that the present invention cover the modifications and verifications of this invention provided they come with the scope of the appended claims and their equivalents.

1. A chain link attached hook comprising:
an “s” shaped hook, having an upper end hook, a lower end hook on the same plane and a body extending between the said end hooks
a loop formed in said body of the “s” shaped hook, which is perpendicular to the plane of the upper end hook and lower end hook

2. The chain link attached hook of claim 1, wherein the said loop is formed around a link in a support chain

3. The chain link attached hook of claim 2, wherein the upper end of hook is detachably engaged with a support structure, and the lower end hook is detachably engaged with a support chain link

4. The chain link attached hook of claim 3, wherein it is part of a hammock support system, the support structure being a hammock support stand, and the support chain being extended from the clew ring of a hammock

5. The chain link attached to claim 1, in which the upper end hook is formed at or near a 30° angle to the said body extending between end hooks

6. The chain link attached hook in claim 1, in which the lower end hook is formed at or near a 45° angle to the said body extending between end hooks
